(19) United States
(12) Patent Application Publication
(10) Pub. No.: US 2013/0145789 A1
(43) Pub. Date: Jun. 13, 2013

(54) CONDENSER FOR VEHICLE

(71) Applicant: Jae Yeon KIM, Hwaseong-si (KR)

(72) Inventor: Jae Yeon KIM, Hwaseong-si (KR)

(73) Assignee: Hyundai Motor Company, Seoul (KR)

(21) Appl. No.: 13/529,829

(22) Filed: Jun. 21, 2012

(30) Foreign Application Priority Data
Dec. 7, 2011 (KR) 10-2011-0130551

(51) Int. Cl. B60H 1/32; F25B 43/00; F25B 39/04

(52) U.S. Cl. 62/239; 62/506; 62/513; 62/474

(57) ABSTRACT

A condenser apparatus may include a first heat-radiating portion formed by stacking a plurality of plates, fluid-connected to the radiator to circulate the coolant, and fluid-connected to the compressor to circulate the refrigerant supplied from the compressor so as to condense the refrigerant through heat-exchange with the coolant and the refrigerant, a second heat-radiating portion integrally formed at a lower portion of the first heat-radiating portion and fluid-connected thereto, and a receiver-drier portion integrally formed at each one end of the first and second heat-radiating portions and fluid-connected to the first heat-radiating portion to receive a condensed refrigerant from the first heat-radiating portion and performing gas-liquid separation and moisture removal of the refrigerant, wherein the first heat-radiating portion may be provided with a gas-liquid separating portion which separates the refrigerant into gas refrigerant and liquid refrigerant.

### CROSS-REFERENCE TO RELATED APPLICATION

The present application claims priority to Korean Patent Application No. 10-2011-0130551 filed in the Korean Intellectual Property Office on Dec. 7, 2011, the entire contents of which is incorporated herein for all purposes by this reference.

### BACKGROUND OF THE INVENTION

1. Field of the Invention

The present invention relates to a condenser for a vehicle. More particularly, the present invention relates to a condenser for a vehicle that is stacked-plate type in which a receiver-drier is integrally formed and that is water-cooled type in which a refrigerant is condensed by using a coolant.

2. Description of Related Art

Generally, an air conditioning for a vehicle maintains suitable cabin temperature regardless of ambient temperature and realizes comfortable indoor environment.

Such an air conditioning includes a compressor compressing a refrigerant, a condenser condensing and liquefying the refrigerant compressed by the compressor, an expansion valve quickly expanding the refrigerant condensed and liquefied by the condenser, and an evaporator evaporating the refrigerant expanded by the expansion valve and cooling air which is supplied to the cabin in which the air conditioning is installed by using evaporation latent heat.

Herein, the condenser cools compressed gas refrigerant of high temperature/pressure by using an outside air flowing into the vehicle when running and condenses it into liquid refrigerant of low temperature.

Such a condenser is generally connected through a pipe to a receiver-drier which is provided for improving condensing efficiency through gas-liquid separation and removing moisture in the refrigerant.

An air-cooled condenser which heat-exchanges with the outside air is mainly used for the condenser for the vehicle. Since such an air-cooled condenser has pin-tube structures, entire size of the condenser may be increased so as to improve cooling performance. Therefore, the air-cooled condenser may be hard to be installed in a small engine compartment.

In order to solve such a problem, a water-cooled condenser which uses coolant as refrigerant is applied to the vehicle.

However, the water-cooled condenser, compared with the air-cooled condenser, has lower condensing temperature of the refrigerant by about 5-15° C., and accordingly difference between the condensing temperature and the ambient temperature is small. Therefore, condensing efficiency may be deteriorated due to small sub-cool effect, and accordingly cooling efficiency may also be deteriorated.

In addition, size of a radiator or capacity of a cooling fan may be increased so as to increase condensing efficiency or cooling efficiency of the water-cooled condenser for the vehicle. Therefore, cost and weight may increase and connections between the receiver-drier and the condenser may be complex.

The information disclosed in this Background of the Invention section is only for enhancement of understanding of the general background of the invention and should not be taken as an acknowledgement or any form of suggestion that this information forms the prior art already known to a person skilled in the art.

BRIEF SUMMARY

Various aspects of the present invention are directed to providing a condenser for a vehicle having advantages of being integrally formed with a receiver-drier and stacking a plurality of plates.

In an aspect of the present invention, a condenser apparatus for a vehicle which is used in an air conditioning having an expansion valve, an evaporator, and a compressor, is provided between the compressor and the expansion valve, and circulates coolant supplied from a radiator so as to condense refrigerant supplied from the compressor through heat-exchange with the coolant and the refrigerant, may include a first heat-radiating portion formed by stacking a plurality of plates, fluid-connected to the radiator to circulate the coolant, and fluid-connected to the compressor to circulate the refrigerant supplied from the compressor so as to condense the refrigerant through heat-exchange with the coolant and the refrigerant, a second heat-radiating portion integrally formed at a lower portion of the first heat-radiating portion and fluid-connected thereto, and a receiver-drier portion integrally formed at each one end of the first and second heat-radiating portions and fluid-connected to the first heat-radiating portion to receive a condensed refrigerant from the first heat-radiating portion and performing gas-liquid separation and moisture removal of the refrigerant, wherein the first heat-radiating portion is provided with a gas-liquid separating portion which separates the refrigerant into gas refrigerant and liquid refrigerant.

The gas-liquid separating portion supplies a separated gas refrigerant and a separated liquid refrigerant to different refrigerant lines and wherein the separated gas refrigerant and the separated liquid refrigerant exchanges heat with the coolant, respectively.

The first heat-radiating portion may further include a first refrigerant line having an end portion into which the coolant flows, and formed at a middle portion in the first heat-radiating portion along a length direction, at least one second refrigerant line formed above the first refrigerant line so as for the separated gas refrigerant separated at the gas-liquid separating portion to flow therein, and at least one third refrigerant line formed below the first refrigerant line so as for the separated liquid refrigerant separated at the gas-liquid separating portion to flow therein.

The gas-liquid separating portion is fluid-connected to the other end portion of the first refrigerant line.

The gas-liquid separating portion is fluid-connected to the second and third refrigerant lines close to an upper portion and a lower portion of the gas-liquid separating portion among the second refrigerant lines and the third refrigerant lines, and is not fluid-connected to the other second and third refrigerant lines by the plates.

The condenser apparatus may further include upper and lower covers mounted respectively at an upper portion and a lower portion of the first and second heat-radiating portions and the receiver-drier portion.

The upper cover is provided with a refrigerant inlet formed at an end portion thereof and fluid-connected to the compressor so as to supply the refrigerant into the first heat-radiating portion, and a coolant outlet formed at the other end portion and fluid-connected to the radiator.

The lower cover is provided with a refrigerant outlet formed at an end portion thereof corresponding to the coolant inlet and fluid-connected to the expansion valve, and a coolant inlet formed apart from the refrigerant outlet at the end portion where the refrigerant outlet is formed and fluid-connected to the radiator.

An end portion of each of the plates forming the second refrigerant line is bent so as to form a wall.

The third refrigerant line is not directly communicated with the coolant inlet by a top plate disposed among the plates forming the third refrigerant line.

The receiver-drier portion is provided with a space formed therein to receive the condensed refrigerant therein, and the condenser apparatus may further include an insertion hole formed corresponding to the space.

A desiccant is inserted in the space through the insertion hole.

A fixing cap for preventing escape of the desiccant inserted in the space and for preventing leakage of the refrigerant supplied to the receiver-drier portion is mounted at the insertion hole.

The first heat-radiating portion may further include a first connecting line formed at an upper portion of the first heat-radiating portion so as to be fluid-connected with the second refrigerant line, and a second connecting line formed at a lower portion of the first heat-radiating portion so as to be fluid-connected with the third refrigerant line, and the first heat-radiating portion supplies the condensed refrigerant to the receiver-drier portion through the first connecting line and the second connecting line.

The second heat-radiating portion is fluid-connected to the receiver-drier portion through a third connecting line, and is adapted for the refrigerant in which the gas-liquid separation and the moisture removal is performed by the receiver-drier portion to exchange heat with the coolant secondarily.

The first and second heat-radiating portions cause the coolant and the refrigerant to exchange heat with each other by means of counterflow of the coolant and the refrigerant.

The radiator is fluid-connected to a reserve tank and a cooling fan is provided at a rear portion of the radiator.

The condenser apparatus may include a heat exchanger formed by stacking a plurality of plates.

According to the condenser for the vehicle, dead volume of the receiver-drier may be minimized and heat-radiating area may be increased. Therefore, cooling efficiency may be improved.

In addition, since the condenser separates refrigerant into gas refrigerant and liquid refrigerant and condenses the gas refrigerant and the liquid refrigerant by using coolant, the number of components may be reduced and connections therebetween may be simplified. Thus, cost and weight may be reduced.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of an air conditioning of a vehicle to which a condenser according to an exemplary embodiment of the present invention is applied.

FIG. 2 is a perspective view of a condenser for a vehicle according to an exemplary embodiment of the present invention.

FIG. 3 is a cross-sectional view taken along a line A-A in FIG. 2.

FIG. 4 is a cross-sectional view taken along a line B-B in FIG. 2.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

Exemplary embodiments and drawings disclosed in this specification represent only a few exemplary embodiments of the present invention and do not represent all the spirit of the present invention. So, it is to be understood that various equivalents and variation can exist at the filing date of the present application.

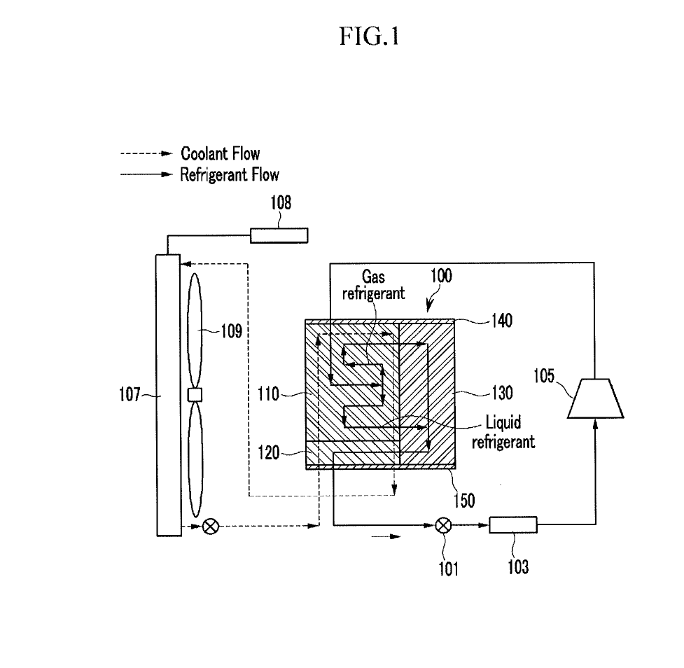

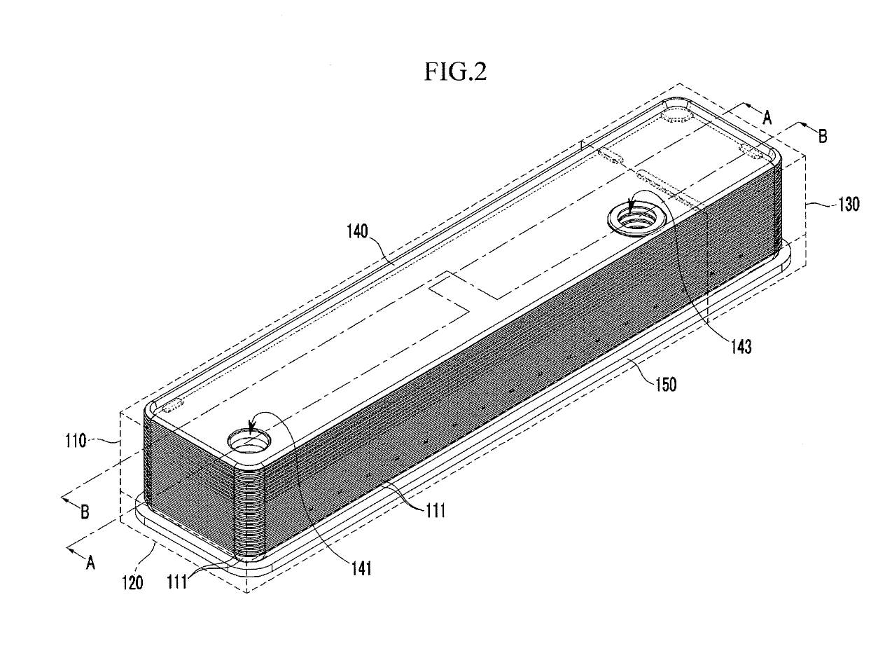

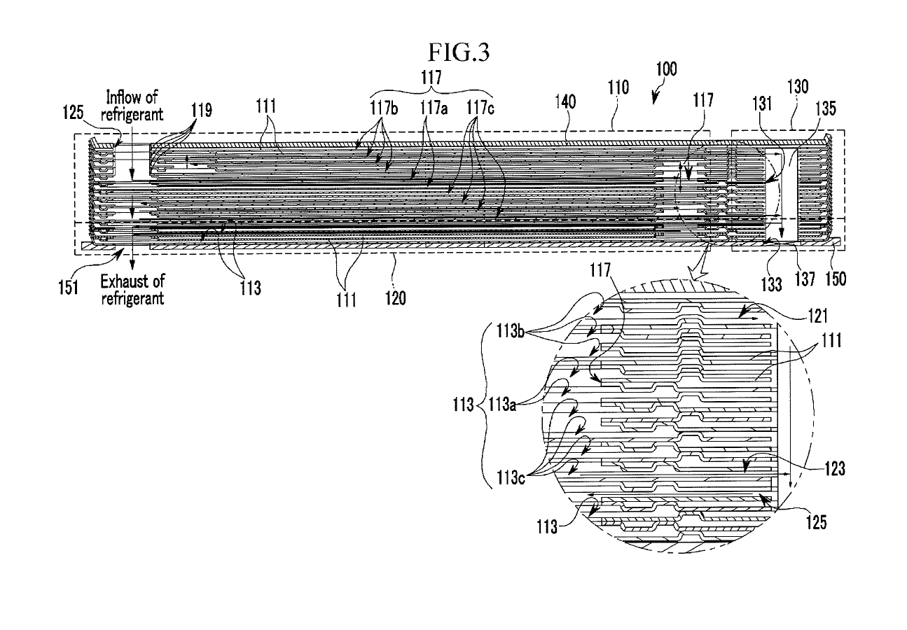

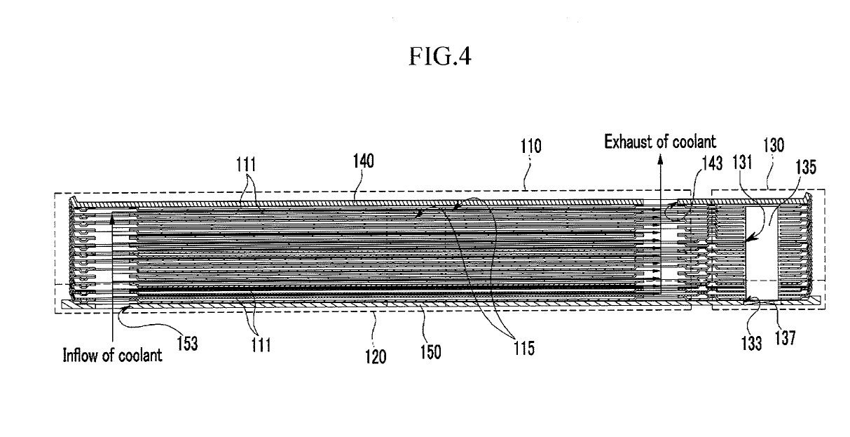

FIG. 1 is a schematic diagram of an air conditioning of a vehicle to which a condenser according to an exemplary embodiment of the present invention is applied, FIG. 2 is a perspective view of a condenser for a vehicle according to an exemplary embodiment of the present invention, FIG. 3 is a cross-sectional view taken along a line A-A in FIG. 2, and FIG. 4 is a cross-sectional view taken along a line B-B in FIG. 2.

A condenser 100 for a vehicle according to an exemplary embodiment of the present invention, as shown in FIG. 1, is used in an air conditioning which includes an expansion valve 101 for expanding a liquid refrigerant, an evaporator 103 for evaporating the refrigerant expanded by the expansion valve 101 through heat-exchange with an air, and a compressor 105 for receiving from the evaporator 103 and compressing a gaseous refrigerant.

That is, the condenser 100 is provided between the compressor 105 and the expansion valve 101, and is configured to circulate a coolant supplied from a radiator 107 and to condense the refrigerant supplied from the compressor 105 through heat-exchange with the coolant.

The radiator 107 is connected to a reserve tank 108, and a cooling fan 109 is provided at a rear portion of the radiator 107.

In the condenser 100 for the vehicle according to an exemplary embodiment of the present invention, a receiver-drier is integrally provided and a plurality of plates is stacked. The condenser 100 for the vehicle separates the refrigerant into and condenses the gas refrigerant and the liquid refrigerant by using the coolant. Therefore, the number of components may be reduced and connections therebetween may be simplified. Thus, cost and weight may be reduced. In addition, since dead volume of the receiver-drier can be minimized and heat-radiating area may be increased, cooling efficiency may be improved according to the condenser 100 for the vehicle.

For these purposes, the condenser 100 for the vehicle according to an exemplary embodiment of the present invention, as shown in FIG. 2 to FIG. 4, includes a first heat-radiating portion 110, a second heat-radiating portion 120 and a receiver-drier portion 130.

Herein, upper and lower covers 140 and 150 are mounted respectively at upper and lower portions of the first and second heat-radiating portions 110 and 120 and the receiver-drier portion 130.

According to the present exemplary embodiment, the first heat-radiating portion 110 is formed by stacking a plurality of plates 111. The first heat-radiating portion 110 is connected to the radiator 107 so as to circulate the coolant, and circulates the refrigerant supplied from the compressor 105 so as to condense the refrigerant through heat-exchange with the coolant.

In addition, the second heat-radiating portion 120 is integrally formed at a lower portion of the first heat-radiating portion 110.

The second heat-radiating portion 120 secondarily cools the condensed refrigerant cooled by the first heat-radiating portion 110.

Herein, the first and second heat-radiating portions 110 and 120 are adapted to perform heat-exchange by means of counterflow of the coolant and the refrigerant.

That is, the plurality of plates 111 is stacked in the first and second heat-radiating portions 110 and 120, and refrigerant lines 113 and coolant lines 115 are alternately formed between the plurality of plates 111. Since the refrigerant passes through the refrigerant line 113 and the coolant passes through the coolant line 115, the refrigerant and the coolant are not mixed to each other and flow to opposite directions. At this process, heat-exchange of the refrigerant and the coolant occurs.

In the present exemplary embodiment, the first heat-radiating portion 110, as shown in FIG. 3, includes a first refrigerant line 113a, a gas-liquid separating portion 117, a second refrigerant line 113b and a third refrigerant line 113c.

The first refrigerant line 113a is formed at a middle portion in the first heat-radiating portion 110 along a length direction. The refrigerant is supplied into an end portion of the first refrigerant line 113a and flows in the refrigerant line 113a.

The gas-liquid separating portion 117 is connected to the other end portion of the first refrigerant line 113a in the first heat-radiating portion 110. The gas-liquid separating portion 117 is adapted to separate the refrigerant flowing in the first refrigerant line 113a into the gas refrigerant and the liquid refrigerant by gravity. The gas refrigerant and the liquid refrigerant are mixed in the refrigerant flowing in the first refrigerant line 113a.

That is, the gas-liquid separating portion 117 separates the refrigerant into the gas refrigerant and the liquid refrigerant by gravity difference between the gas refrigerant and the liquid refrigerant when the refrigerant in which the gas refrigerant and the liquid refrigerant are mixed is supplied. At this time, the gas refrigerant is positioned at an upper portion of the gas-liquid separating portion 117 and the liquid refrigerant is positioned at a lower portion of the gas-liquid separating portion 117.

In the present exemplary embodiment, a plurality of second refrigerant lines 113b is formed above the first refrigerant line 113a. The light gas refrigerant separated at the gas-liquid separating portion 117 flows in the second refrigerant line 113b.

The second refrigerant line 113b, when the gas refrigerant separated at the gas-liquid separating portion 117 flows therein, is adapted to perform heat-exchange with the gas refrigerant and the coolant so as to condense the gas refrigerant again.

In addition, a plurality of third refrigerant lines 113c is formed below the first refrigerant line 113a. The heavy liquid refrigerant separated at the gas-liquid separating portion 117 flows in the third refrigerant line 113a.

The third refrigerant line 113c, when the liquid refrigerant separated at the gas-liquid separating portion 117 flows therein, is adapted to perform heat-exchange with the liquid refrigerant and the coolant so as to condense the liquid refrigerant.

Herein, the gas-liquid separating portion 117 is connected respectively to the second and third refrigerant lines 113b and 113c close to upper and lower portions of the gas-liquid separating portion 117 among the plurality of second refrigerant lines 113b and third refrigerant lines 113c, and is not connected to other second and third refrigerant lines 113b and 113c by the plates 111.

That is, the plate 111 is adapted to close the upper and lower portions of the gas-liquid separating portion 117 such that the gas refrigerant and the liquid refrigerant does not flow into the second and third refrigerant lines 113b and 113c other than the second and third refrigerant lines 113b and 113c close to upper and lower portions of the gas-liquid separating portion 117.

According to the present exemplary embodiment, a refrigerant inlet 141 is formed at an end portion of the upper cover 140. The refrigerant inlet 141 is connected to the compressor 105 and is adapted to flow the refrigerant into the first heat-radiating portion 110.

In addition, a coolant outlet 143 is formed at the other end portion of the upper cover 140 close to the receiver-drier portion 130. The coolant outlet 143 is connected to the radiator 107.

Herein, an end portion of each plate 111 forming the second refrigerant line 113b is bent so as to form a wall 119. The end portion of each plate 111 is an end portion disposed close to the refrigerant inlet 141.

The wall 119 is adapted to prevent the refrigerant supplied through the refrigerant inlet 141 from flowing into the second refrigerant line 113b formed at an upper portion of the first heat-radiating portion 110.

In addition, the third refrigerant line 113c is not directly communicated with the refrigerant inlet 141 by the top plate 111 among the plates 111 forming the third refrigerant line 113c.

Therefore, the refrigerant supplied through the refrigerant inlet 141 is prevented from flowing directly into the third refrigerant line 113c by the top plate 111 among the plates 111 forming the third refrigerant line 113c and flows into the first refrigerant line 113a.

According to the present exemplary embodiment, a refrigerant outlet 151 is formed at an end portion of the lower cover 150 corresponding to the refrigerant inlet 141. The refrigerant outlet 151 is connected to the expansion valve 101.

A coolant inlet 153 is formed at the end portion of the lower cover 150 where the refrigerant outlet 151 is formed and is disposed apart from the refrigerant outlet 151, as shown in FIG. 4. The coolant inlet 153 is connected to the radiator 107.

That is, since the low-temperature coolant supplied through the refrigerant inlet 141 formed at the lower cover 150 flows into the second heat-radiating portion 120 firstly, the refrigerant passing through the first heat-radiating portion 110 is additionally cooled. Therefore, cooling efficiency may be improved.

In addition, the receiver-drier portion 130 is adapted to receive the condensed refrigerant through the first heat-radiating portion 110 and to perform gas-liquid separation and moisture removal of the refrigerant. The receiver-drier portion 130 is integrally formed at the other end of the first and second heat-radiating portions 110 and 120 and is connected to the first and second heat-radiating portions 110 and 120.

The refrigerant flowing in the first heat-radiating portion 110 is separated into the gas refrigerant and the liquid refrigerant by the gas-liquid separating portion 117, and the gas refrigerant and the liquid refrigerant flow respectively through the second and third refrigerant lines 113b and 113c so as to exchange heat with the coolant and to be condensed.

After that, the condensed refrigerant is discharged to the receiver-drier portion 130 through a first connecting line 121 formed at the upper portion of the first heat-radiating portion 110 and connected to the second refrigerant line 113b and a second connecting line 123 formed at the lower portion of the first heat-radiating portion 110 and connected to the third refrigerant line 113c.

In addition, the second heat-radiating portion 120 is connected to the receiver-drier portion 130 through a third connecting line 125. The second heat-radiating portion 120 is adapted to receive the refrigerant which is discharged from the first heat-radiating portion 110 through the second and third connecting lines 121 and 123 and in which gas-liquid separation and moisture removal is performed during passing through the receiver-drier portion 130. After that, the second heat-radiating portion 120 causes the low-temperature refrigerant to exchange heat with the coolant secondarily so as to cool the refrigerant additionally.

Since the receiver-drier portion 130 uses a receiver-drier having the same shape as the condenser 100, dead volume thereof may be minimized and additional connecting pipes may be removed, compared with a conventional receiver-drier of cylindrical shape.

The receiver-drier portion 130 is integrally formed at the other end of the first and second heat-radiating portions 110 and 220. The receiver-drier portion 130 is not fluidly connected to the first and second heat-radiating portions 110 and 120 at positions other than the first and second and the third connecting lines 121, 123, and 125. Therefore, the refrigerant cannot flow into the receiver-drier portion 130 through the positions other than the first and second and the third connecting lines 121, 123, and 125.

Herein, a space 131 is formed in the receiver-drier portion 130, and an insertion hole 133 is formed at the lower cover 113 corresponding to the space 131.

According to the present exemplary embodiment, a desiccant 135 is inserted in the space 131 through the insertion hole 133 and removes moisture in the condensed refrigerant.

The desiccant 135 can be replaced through the insertion hole 133 according to replacement period. That is, the desiccant 135 is replaceably mounted in the receiver-drier portion 130.

Meanwhile, a filter is integrally formed with the desiccant 135, and the filter removes foreign materials contained in the refrigerant supplied to the receiver-drier portion 130.

That is, the receiver-drier portion 130 removes the moisture remaining in the refrigerant by the desiccant 135 and filters the foreign materials contained in the refrigerant by the filter. Therefore, it is prevented for the foreign materials remaining in the refrigerant from flowing into the expansion valve 101.

Accordingly, it is prevented for the foreign materials remaining in the refrigerant from blocking the expansion valve 101.

A fixing cap 137 for preventing escape of the desiccant 135 inserted in the space 131 and for preventing leakage of the refrigerant supplied to the receiver-drier portion 130 is mounted at the insertion hole 133.

As described above, the condenser 100 according to an exemplary embodiment of the present invention includes a heat exchanger formed by stacking the plurality of plates 111.

That is, the coolant cooled by the radiator 107 firstly flows into the second heat-radiating portion 120 through the coolant inlet 153 and flows to the first heat-radiating portion 110 through the coolant lines 115 formed between the plurality of plates 111 so as to circulate in the condenser 100. After that, the coolant flows out through the coolant outlet 143.

At this time, the refrigerant flows from the compressor 105 into the first heat-radiating portion 110 through the refrigerant inlet 141, and flows to the gas-liquid separating portion 117 through the first refrigerant line 113a among the refrigerant line 113 alternately formed with the coolant line 115.

The refrigerant is separated into the gas refrigerant and the liquid refrigerant at the gas-liquid separating portion 117, and the gas refrigerant and the liquid refrigerant flows in the second refrigerant line 113b and the third refrigerant line 113c and exchange heat with the coolant, respectively.

At this time, the gas refrigerant and the liquid refrigerant separated at the gas-liquid separating portion 117 and the coolant flowing in the coolant line 115 flows to opposite directions and exchange heat with each other.

In addition, the condensed refrigerant cooled at the first heat-radiating portion 110 flows to the receiver-drier portion 130 through the first connecting line 121 and the second connecting line 123.

The condensed refrigerant circulates in the receiver-drier portion 130. At this time, gas-liquid separation is performed and the moisture in the refrigerant is removed by the desiccant 135. After that, the condensed refrigerant is supplied to the second heat-radiating portion 120 through the third connecting line 125.

The refrigerant supplied to the second heat-radiating portion 120 flows in an opposite direction of the low-temperature coolant supplied firstly to the second heat-radiating portion 120 and exchanges heat with the low-temperature coolant secondarily. Therefore, the coolant is additionally cooled.

After that, the refrigerant secondarily cooled at the second heat-radiating portion 120 is supplied to the expansion valve 101 through the refrigerant outlet 151.

Since the receiver-drier portion 130 is integrally formed with the first and second heat-radiating portions 110 and 120, additional connection pipes for connecting the receiver-drier portion 130 to the first and second heat-radiating portions 110 and 120 can be removed. In addition, since receiver-drier of the receiver-drier portion 130 has the same shape as the condenser 100, dead volume can be minimized.

It is exemplified but is not limited to that the first and second heat-radiating portions 110 and 120 and the receiver-drier portion 130 are formed by stacking the plurality of plates 111 between the upper and lower covers 140 and 150. The plurality of plates 111 without the upper and lower covers 140 and 150 can form the first and second heat-radiating portions 110 and 120 and the receiver-drier portion 130.

The condenser 100 for the vehicle according to an exemplary embodiment of the present invention is integrally formed with the receiver-drier, is formed by stacking the plurality of plates, and is adapted to separate the refrigerant the gas refrigerant and the liquid refrigerant and to condense the gas refrigerant and the liquid refrigerant. Therefore, the number of components may be reduced and connections therebetween may be simplified. In addition, cost and weight may be reduced.

The condenser 100 separates the refrigerant flowing in the first heat-radiating portion 110 into the gas refrigerant and the liquid refrigerant at the gas-liquid separating portion 117, and the gas refrigerant and the liquid refrigerant exchange heat with the coolant and is condensed, respectively. Therefore, heat-exchanging efficiency may be improved.

Since the receiver-drier is integrally formed with the heat-radiating portions 110 and 120, dead volume in the condenser 100 may be reduced. Therefore, heat-radiating area of the condenser 100 may be increased and condensing efficiency and cooling efficiency may be improved without increasing the size of the condenser 100. Therefore, marketability may be improved.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A condenser apparatus for a vehicle which is used in an air conditioning having an expansion valve, an evaporator, and a compressor, is provided between the compressor and the expansion valve, and circulates coolant supplied from a radiator so as to condense refrigerant supplied from the compressor through heat-exchange with the coolant and the refrigerant, the condenser apparatus comprising:
a first heat-radiating portion formed by stacking a plurality of plates, fluid-connected to the radiator to circulate the coolant, and fluid-connected to the compressor to circulate the refrigerant supplied from the compressor so as to condense the refrigerant through heat-exchange with the coolant and the refrigerant;
a second heat-radiating portion integrally formed at a lower portion of the first heat-radiating portion and fluid-connected thereto; and
a receiver-drier portion integrally formed at each one end of the first and second heat-radiating portions and fluid-connected to the first heat-radiating portion to receive a condensed refrigerant from the first heat-radiating portion and performing gas-liquid separation and moisture removal of the refrigerant,
wherein the first heat-radiating portion is provided with a gas-liquid separating portion which separates the refrigerant into gas refrigerant and liquid refrigerant.

2. The condenser apparatus of claim 1, wherein the gas-liquid separating portion supplies a separated gas refrigerant and a separated liquid refrigerant to different refrigerant lines and wherein the separated gas refrigerant and the separated liquid refrigerant exchanges heat with the coolant, respectively.

3. The condenser apparatus of claim 2, wherein the first heat-radiating portion further includes:
a first refrigerant line having an end portion into which the coolant flows, and formed at a middle portion in the first heat-radiating portion along a length direction;
at least one second refrigerant line formed above the first refrigerant line so as for the separated gas refrigerant separated at the gas-liquid separating portion to flow therein; and
at least one third refrigerant line formed below the first refrigerant line so as for the separated liquid refrigerant separated at the gas-liquid separating portion to flow therein.

4. The condenser apparatus of claim 3, wherein the gas-liquid separating portion is fluid-connected to the other end portion of the first refrigerant line.

5. The condenser apparatus of claim 3, wherein the gas-liquid separating portion is fluid-connected to the second and third refrigerant lines close to an upper portion and a lower portion of the gas-liquid separating portion among the second refrigerant lines and the third refrigerant lines, and is not fluid-connected to the other second and third refrigerant lines by the plates.

6. The condenser apparatus of claim 3, further including upper and lower covers mounted respectively at an upper portion and a lower portion of the first and second heat-radiating portions and the receiver-drier portion.

7. The condenser apparatus of claim 6, wherein the upper cover is provided with a refrigerant inlet formed at an end portion thereof and fluid-connected to the compressor so as to supply the refrigerant into the first heat-radiating portion, and a coolant outlet formed at the other end portion and fluid-connected to the radiator.

8. The condenser apparatus of claim 7, wherein the lower cover is provided with a refrigerant outlet formed at an end portion thereof corresponding to the coolant inlet and fluid-connected to the expansion valve, and a coolant inlet formed apart from the refrigerant outlet at the end portion where the refrigerant outlet is formed and fluid-connected to the radiator.

9. The condenser apparatus of claim 7, wherein an end portion of each of the plates forming the second refrigerant line is bent so as to form a wall.

10. The condenser apparatus of claim 7, wherein the third refrigerant line is not directly communicated with the coolant inlet by a top plate disposed among the plates forming the third refrigerant line.

11. The condenser apparatus of claim 1, wherein the receiver-drier portion is provided with a space formed therein to receive the condensed refrigerant therein, and the condenser apparatus further includes an insertion hole formed corresponding to the space.

12. The condenser apparatus of claim 11, wherein a desiccant is inserted in the space through the insertion hole.

13. The condenser apparatus of claim 12, wherein a fixing cap for preventing escape of the desiccant inserted in the space and for preventing leakage of the refrigerant supplied to the receiver-drier portion is mounted at the insertion hole.

14. The condenser apparatus of claim 3, wherein the first heat-radiating portion further includes a first connecting line formed at an upper portion of the first heat-radiating portion so as to be fluid-connected with the second refrigerant line, and a second connecting line formed at a lower portion of the first heat-radiating portion so as to be fluid-connected with the third refrigerant line, and
the first heat-radiating portion supplies the condensed refrigerant to the receiver-drier portion through the first connecting line and the second connecting line.

15. The condenser apparatus of claim 14, wherein the second heat-radiating portion is fluid-connected to the receiver-drier portion through a third connecting line, and is adapted for the refrigerant in which the gas-liquid separation and the moisture removal is performed by the receiver-drier portion to exchange heat with the coolant secondarily.

16. The condenser apparatus of claim 1, wherein the first and second heat-radiating portions cause the coolant and the refrigerant to exchange heat with each other by means of counterflow of the coolant and the refrigerant.

17. The condenser apparatus of claim 1, wherein the radiator is fluid-connected to a reserve tank and a cooling fan is provided at a rear portion of the radiator.

18. The condenser apparatus of claim 1, wherein the condenser apparatus includes a heat exchanger formed by stacking a plurality of plates.
